(19) United States
(12) Patent Application Publication
(10) Pub. No.: US 2008/0241399 A1
(43) Pub. Date: Oct. 2, 2008

(54) Method of coating and coated sheet piling sections

(75) Inventors: Morrison Lee Wilkins, Marietta, OH (US); Michael Chefren, Bridgeport, WV (US)

Correspondence Address: HOFFMANN & BARON, LLP, 6900 JERICHO TURNPIKE, SYOSSET, NY, 11791, US

(73) Assignee: Skyline Steel, LLC.

(21) Appl. No.: 11/731,576

(22) Filed: Mar. 30, 2007

(51) Int. Cl. B05D 3/12

(52) U.S. Cl. 427/292; 428/416

(57) ABSTRACT

A coated sheet piling section that includes: a steel core having a pair of opposing surfaces; a primer layer on each surface; a cycloaliphatic amine epoxy layer on each primer layer; and an aliphatic acrylic polyurethane disposed on one or both of the two cycloaliphatic amine epoxy layers. The primer is preferably an inorganic zinc primer. The cycloaliphatic amine epoxy layers have a thickness of from about 4 mils to about 16 mils and the aliphatic acrylic polyurethane layers have a thickness of from about 2 mils to about 14 mils.

### FIELD OF THE INVENTION

The present invention relates to sheet piling sections that are coated to provide protection against corrosion (rust) and abrasion. In particular, the present invention relates to sheet piling sections which are coated using two different coating materials in a multi-step process to provide maximum rust/corrosion protection and abrasion resistance. The present invention also relates to a method for forming such coated sheet piling sections.

### BACKGROUND OF INVENTION

Sheet piling sections have many uses as ground barriers for preventing the passage of water or the shifting of the ground. In many applications, sheet piling sections have to withstand harsh environmental conditions, such as salt water, winds and extremes in temperatures, over prolonged periods of time. When used in harsh marine or riverine environments steel sheet piling sections must resist rust and corrosion, as well as significant abrasive forces caused by wind blown sand and debris. Moreover, vessels, vehicles or water borne objects, such as ice and pieces of wood, can oftentimes collide with the sheet piling sections. In certain situations where there is little or no oxygen (e.g., deep under the ground), steel sheet piling may not corrode. However, in most situations, when exposed to the atmosphere in an industrial or coastal area, to seawater, to freshwater, to polluted or disturbed ground, or to anaerobic bacteria, protection from corrosion is essential. To counteract these conditions, sheet piling sections have been painted or coated with various materials in an attempt to provide a degree of protection.

Paints and coatings have been found to be effective for short periods of time in such environments but, generally, begin to break down and expose the steel sheet piling sections within a fairly short period of time. In addition, a deep scratch or gouge in the paint or coating can cause rust and corrosion to spread at an accelerated rate. Thus, painted or coated steel sheet piling sections require frequent scraping or sanding and repainting in order to maintain their appearance and structural integrity. Such high maintenance is costly and not always practical, since only the exposed, above-ground portion of the sheet piling section can be easily accessed. Moreover, installed sheet piling sections typically have most of their surfaces below ground level or submerged in water on at least one side, making it impractical or impossible to perform maintenance.

There are three recognized ways that coatings can protect steel: barrier protection, inhibition, and sacrificial action. A coating protects as a barrier by blocking moisture, oxygen, and other chemicals from the steel substrate. All coatings are permeable to some degree, but those coatings that protect through a barrier mechanism have relatively low moisture permeability. Coatings that protect by inhibition contain special pigments to inhibit or interfere with the corrosion reactions on the steel surface. As moisture passes through the coating film, the anti-corrosive pigments slowly dissolve and aid in stopping corrosion. Finally, sacrificial action is the method used by zinc- and aluminum-rich coatings. If a surface protected by a zinc coating is scratched, the zinc protects the surrounding area by setting up a small electrochemical cell in which the zinc reacts (and is “sacrificed”), but the surrounding steel is substantially unharmed.

In the past, epoxy coatings have been used for articles made of steel and other metals to seal the surface and provide protection from the environment. Epoxy coatings are widely used on metal surfaces where corrosion (rusting) resistance is important, such as marine applications and weatherproof enclosures. In addition, metal cans and containers are often coated with epoxy to prevent rusting, especially for foods like tomatoes that are acidic. However, epoxy coatings do not hold up well to highly abrasive forces and, in many applications, epoxy coatings have been found to be unsatisfactory.

Polyurethane has been used for coating metals but it is most frequently used for protecting wood surfaces and plastic or wood composite flooring products. Polyurethane materials are commonly formulated as paints and varnishes for finishing coats to protect or seal wood. This use results in a hard, abrasion-resistant, and durable coating. Relative to oil or shellac varnishes, polyurethane varnish forms a harder film which tends to de-laminate if subjected to heat or shock, fracturing the film and leaving white patches. Various priming techniques are employed to overcome this problem, including the use of certain oil varnishes, specified “dewaxed” shellac, clear penetrating epoxy, or “oil-modified” polyurethane designed for the purpose.

Polyurethane may also be applied over a straight oil finish, but because of the relatively slow curing time of oils, the presence of volatile byproducts of curing, and the need for extended exposure of the oil to oxygen, care must be taken that the oils are sufficiently cured to accept the polyurethane. “Oil-modified” polyurethanes, whether water-borne or solvent-borne, are currently the most widely used wood floor finishes.

The painted or coated steel sheet piling sections that are currently in use cannot satisfactorily protect the underlying steel from the harsh environments in which they are frequently used. The attempts to improve the coatings have not been entirely successful and there is still a need for a coating material for steel sheet piling sections which can withstand harsh conditions without peeling or allowing the underlying steel sheet piling to rust or corrode. Accordingly, the present invention provides a coating for sheet piling sections that not only protects the underlying steel from rust and corrosion but also provides superior abrasion resistance for the surface.

### SUMMARY OF THE INVENTION

In accordance with the present invention, a coated steel sheet, preferably a steel sheet piling section is provided, which includes: a steel core having a pair of opposing surfaces; a first and a second cycloaliphatic amine epoxy layer, wherein the steel core is disposed between the cycloaliphatic amine epoxy layers; and a first layer of aliphatic acrylic polyurethane disposed on one of the two cycloaliphatic amine epoxy layers. The coated sheet piling section can also have a second layer of aliphatic acrylic polyurethane disposed on the uncoated cycloaliphatic amine epoxy layer. The cycloaliphatic amine epoxy layers have a thickness of from about 4 mils to about 16 mils, preferably from about 6 mils to about 14 mils, more preferably from about 8 mils to about 12 mils and most preferably about 8 mils. The aliphatic acrylic polyurethane layers have a thickness of from about 2 mils to about 14 mils, preferably from about 4 mils to about 12 mils, more preferably from about 6 mils to about 10 mils and most preferably about 10 mils. The thicknesses of the cycloaliphatic amine epoxy layers and the aliphatic acrylic polyurethane layers can be achieved by the application of either a single coat or by the application of multiple coats.

The coated sheet piling section can also include a primer layer on one or both sides, between the cycloaliphatic amine epoxy layer and the steel core. Any primer suitable for coating steel can be used, preferably zinc primers, and most preferably inorganic zinc primers. Preferably, the opposing surfaces of the steel core are substantially free of oxidized metals prior to the application of the primer and/or the cycloaliphatic amine epoxy layer. In one embodiment, the first and/or second cycloaliphatic amine epoxy layers have a first thickness and the first and/or second aliphatic acrylic polyurethane layers have a second thickness. High moisture barriers and high impact resistance are provided when the ratio of the first thickness to the second thickness is from about 2:1 to about 1:2, preferably from about from about 3:2 to about 1:1, and most preferably about 5:4.

The present invention is also a method of forming a durable steel sheet piling section. The method includes: providing a steel sheet piling section having a pair of opposing surfaces; abrading the opposing surfaces of the steel sheet piling section, preferably by sand blasting, to substantially remove all metal oxides; applying a cycloaliphatic amine epoxy layer to each of the opposing surfaces; and applying an aliphatic acrylic polyurethane layer onto one or both of the cycloaliphatic amine epoxy layers. In preferred embodiments, a primer layer is applied to the abraded opposing surfaces prior to applying the epoxy layers. Sheet piling sections of any thickness can be coated using the method of the present invention. However, preferred sheet piling sections have a thickness of from about 0.375 to about 1 inch.

When the surfaces of the sheet piling section are abraded, preferably, about 1 mil of thickness is removed from each of the opposing surfaces. This ensures that substantially all of the metal oxides and/or hydroxides that are on the surfaces are removed. After the surfaces are abraded, they are thoroughly cleaned to remove all dust and dirt. An industrial liquid cleaner or a solvent can be used to remove any oil or grease. The surfaces are then coated sequentially with an optional primer, one or more cycloaliphatic amine epoxy layers and one or more aliphatic acrylic polyurethane layers, with sufficient time intervals between application of the layers to allow for proper curing and/or drying.

The sheet piling sections coated in accordance with the present invention have been shown to have excellent moisture barrier properties and to be highly resistant to abrasion. Performance testing of these sheet piling sections demonstrates that they are significantly more durable than sheet piling sections coated with prior art coatings.

### BRIEF DESCRIPTION OF THE FIGURES

The preferred embodiments of the coated steel sheet piling sections of the present invention, as well as other objects, features and advantages of this invention, will be apparent from the following detailed description, which is to be read in conjunction with the accompanying drawings wherein:

FIG. 1 shows a preferred structure having a steel core coated with an epoxy layer on both sides of the steel core and one polyurethane exterior layer.

FIG. 2 shows a preferred structure having a steel core coated with an epoxy layer on both sides of the steel core and two polyurethane exterior layers.

FIG. 3 shows a preferred structure having a steel core coated with a primer layer and an epoxy layer on both sides of the steel core and one polyurethane exterior layer.

FIG. 4 shows a preferred structure having a steel core coated with a primer layer and an epoxy layer on both sides of the steel core and two polyurethane exterior layers.

### DETAILED DESCRIPTION OF THE INVENTION

The present invention is a method for coating metal surfaces, such as alloy steel, stainless steel, iron, nickel, nickel-based alloys or aluminum. In particular, the present invention is a method of coating steel sheet piling sections and the coated sheet piling sections formed using the method. Any metal that is exposed to corrosive environments needs to be protected so that it does not prematurely breakdown. The present invention provides a method of coating metals to prevent moisture and other oxidizing agents from contacting the surfaces of the metals. In preferred embodiments, these coatings are used to protect steel sheet piling sections.

The coating system of the present invention and the method of applying the system includes a plurality of steps for preparing and coating metal surfaces. In the first step, the metal is prepared for coating by removing oxidized metal, dirt and other unwanted materials from the surfaces that are being coated, preferably by abrading the surfaces. As used herein, the term “abrade” means to rub or wear away, especially by friction. In the preparation of metal surfaces for painting or coating, sanding and sandblasting are two examples of abrasion methods. However, the use of the term “abrade” is not limited to these examples and can include any method or technique for removing unwanted materials from a metal surface. After the surface is abraded, solvents or other cleaning solutions can be used to remove any dust or dirt that may remain on the surface of the metal.

One or more primer coats can then be applied to the prepared surface to prevent oxidation of the metal and provide a more receptive surface for subsequent coatings. The number of primer coats that are used depends on a number of factors, including the type of metal that is being coated, the intended use of the coated metal, the type of primer that is being used and the type of coating that will be applied to the primer. In some circumstances, it may not be necessary to use a primer and the coatings can be applied directly to the metal surface. Preferably, the first primer coat (or any other first coat) should be applied within 24 hours after the metal surface is abraded, preferably within 8 hours and most preferably within 3 hours. A first coat should be applied to the metal surface as soon as possible, since oxidation begins as soon as the abrading step exposes the metal surface.

After the abraded metal has been prepared by cleaning and, optionally, priming the surface, a first epoxy coat can be applied to one or more surfaces of the metal. In the case of metal sheets, there are considered to be two surfaces with the adjacent edges considered to be coated if a coating is applied to either surface. When the one or more epoxy coatings have completely dried, one or more top (or exterior) coatings of polyurethane is applied on one or more of the epoxy coated surfaces. The number and thickness of the coatings of epoxy and polyurethane that are applied depend on how the coated metal will be used. For particularly corrosive environments, the total epoxy thickness of the one or more layers can be increased to provide greater protection. For applications where the coated metal will be subjected to physical abuse, the thickness of the one or more layers of polyurethane can be increased to provide a more abrasion resistant exterior surface.

The application of the coating system is preferably carried out in a dry environment to facilitate the curing and/or drying of the primer, the epoxy and the polyurethane layers. The coatings can be applied using either a brush, a roller or by spraying. Sufficient time should be allowed between the application of layers to allow curing/drying of the coats to be substantially completed. The methods used for applying and curing/drying the coatings are well know to those of ordinary skill in the art.

As used herein, the terms “layer” and “coating” have the same meaning and refer to a material applied to a surface. A layer or coating of any particular material can be formed by a single application or it can be formed by successive applications of the same material. For example, an epoxy layer (or coating) having a thickness of 9 mils is referred to as an epoxy layer either if the 9 mils of epoxy is applied in a single spraying operation or if three 3 mils thick layers of epoxy is applied in three successive spraying operations. Multiple layers of the same material are considered to be a single layer unless otherwise stated, or unless there is an intervening layer of a different material between the multiple layers.

### Surface Preparation

Before the coating process begins, the steel sheet piling sections must be prepared so that the coatings will properly adhere to the steel surfaces. Hot-rolled steel has a surface oxide layer, which includes oxidized metals, known as “millscale.” This bluish oxide layer is brittle and only partly adherent to the steel surface. When the steel is exposed to air and water, it corrodes rapidly in the areas not covered by millscale. The corrosion quickly spreads under the millscale, causing it to flake off. If steel covered with millscale is coated, the corrosion reaction still takes place under the coating, although at a slower rate. The result is eventual coating breakdown. For this reason, removal of the millscale before coating is preferred.

A variety of different abrading methods can be used to remove millscale as well as dirt, oil and/or grease from the surfaces of steel sheets, preferably steel sheet piling sections. These methods include blast cleaning or sanding, using either clean dry sand, steel shot, mineral grit or manufactured grit of a gradation that produces a uniform 1 to 2 mils (0.025 to 0.05 mm) profile on the abraded surface. The sandblasting methods are well known to those skilled in the art of metal painting and coating. Preferably, the abrasion methods remove at least 1 mil of material from the surfaces of the sheet piling sections and more preferably 2 mils. Abrasive blasting with grit or shot is one of the most efficient ways of removing scale and is the preferred method of cleaning steel. An additional advantage of abrasive blasting is that it roughens the steel surface, providing a good bond for the adhesion of coatings. This is particularly important for the heavy-duty coatings used for applications such as resistance against severe abrasion.

The surfaces of the steel sheet piling sections which are being coated are prepared by sand blasting, preferably to conform to standard ISO 8501-1 of the International Organization for Standardization. This is the internationally accepted standard for determining the degree of cleanliness of abrasive blast-cleaned steel. The preferred preparation grade is ISO Sa 3 (blast cleaning to visually clean steel), and more preferably ISO Sa 2,5 (very thorough blast cleaning). Once a surface is sand blasted, it should be coated as soon as possible since the abraded surface begins to oxidize almost immediately after the blasting stops. If prepared surfaces are contaminated by rust or other contaminants, or more than 24 hours has passed since the surfaces were prepared, they can be reblasted prior to coating.

### Coating Systems

The coating systems of the present invention generally consist of one or two primers, at least one intermediate coat, and a top coat (or exterior coat). The primer of a coating system for steel has a significant influence on the anti-corrosive properties of the total system. It provides good adhesion to the surface, a mechanism of corrosion inhibition, and a good base for the intermediate and top coats. In most cases, a zinc primer is preferred because of its good corrosion-inhibiting properties.

The intermediate coat increases the total thickness and, thus, increases the distance for moisture diffusion to the surface. The top coat is selected for color and gloss retention, for chemical resistance, or for additional resistance to mechanical damage such as abrasion. Generally, epoxies are used for seawater immersion and chemical resistance, polyurethanes for color and gloss retention. It has been found that surprisingly good barrier properties and impact resistance is achieved when there is a specific ratio between the thickness of the epoxy layers and thickness of the polyurethane layers. When the first and/or second cycloaliphatic amine epoxy layers have a first thickness and the first and/or second aliphatic acrylic polyurethane layers have a second thickness, good results have been obtained when the ratio of the first thickness to the second thickness is from about 2:1 to about 1:2. A more preferred ratio of the first thickness to the second thickness is from about 3:2 to about 1:1, and the most preferred ratio is about 5:4. It has been found that the preferred thickness ratios provide maximum protection of the underlying steel against moisture and abrasion at a minimal cost.

When the coating systems of the present invention are used for sheet piling sections, each user has different requirements. In some cases, it may be possible to apply an entire coating system in the factory, in other cases, perhaps just one or two coats can be applied in the factory and the remainder are applied when the sheet piles arrive at the site where they are being installed. The entire coating system is often not applied at the factory for fear of damage to the coating during shipment to the user. When a zinc primer is factory-applied, the application of a sealer has a number of advantages. These include easier removal of contamination, prevention of zinc-salt formation and easier top coating on site. Coating systems are designed for different applications, which can require coatings that are highly abrasion resistant and/or impact-resistant. The thicknesses of the layers of a coating system can also vary according to the shape of the coated structure. For sheet piling sections, the flat surfaces typically have a thinner coating than the irregular surfaces, such as the joints for connecting adjacent sheet piling sections. In most cases, the preferred coating systems of the present invention can be applied at the factory, prior to shipping to the end user, due to the highly abrasion-resistant exterior layer.

### Surface Primer

After sandblasting the surfaces of the sheet piling sections, some metal hydroxides/oxides may still be present on the surface if the sandblasting was not done properly or if there is a time lapse between the sandblasting and the application of the coatings. Metal hydroxides/oxides do not provide a solid surface for the adhesion of the epoxy coating, and they will cause the epoxy to come off in large flakes. Therefore, using a primer provides extra insurance that the epoxy will properly adhere to the steel.

In preferred embodiments, a primer is applied to the surface of the steel sheet piling section as a preparatory coating before the epoxy and polyurethane coatings. Priming ensures better adhesion of the epoxy to the surface, increases durability of the epoxy layer, and provides additional protection for the sheet piling sections. A primer should be used if the surfaces of the sheet piling sections are in poor condition, for example if there are traces of rust on the surfaces, and thorough cleaning of the steel surfaces is not a viable option. This is frequently the case when the coating system is being applied to installed sheet piling sections. Preferred primers chemically convert rust to solid metal salts and provide an acceptable surface for applying the epoxy coating, even though such a surface is lacking in comparison to the shiny clean surface of a properly abraded sheet piling section.

Although a primer is not required, it is highly preferred since in most applications the sheet piling sections will be exposed to moisture. If water were to seep through the epoxy layer to the bare steel, oxidation would begin and the steel would rust. The preferred metal primers contain additional materials or additives to protect against corrosion, such as zinc rich primers, which contain sacrificial zinc that reacts with moisture to protect steel surfaces from corrosion. Unlike regular paints or epoxies, which resist corrosion by forming an impermeable barrier between the metal and atmospheric moisture, zinc rich primers provide corrosion protection by electrical means. The zinc and the steel form a tiny electrical-cathodic cell that protects the steel at the expense of the zinc. In addition, the layer of zinc primer acts as a barrier and also provides some protection for the steel.

There are two types of zinc primers, organic and inorganic. One widely used organic zinc primer is formed by mixing zinc in an epoxy. Another type of organic zinc primer is a moisture cured urethane zinc primer. Typically, moisture cured urethane coatings are easier to apply than epoxy based organic zinc primers. In many applications, inorganic zinc primers are preferred over organic zinc primers because they can be used as a stand alone coating and do not require a topcoat. However, topcoating either an organic or inorganic zinc primer with a paint or epoxy provides a backup, or secondary layer, for protecting the underlying steel from corrosion.

### Epoxy Layer

After the metal surface or surfaces have been prepared, an epoxy coating is applied. A primer can be applied to the prepared metal surfaces prior to the epoxy coating, but the epoxy coating can be applied successfully without any sort of general purpose primer or zinc primer. If an epoxy coating is used without a primer, it should be applied as soon as possible after the metal surface is abraded and cleaned. Preferably, within 8 hours, more preferably within 3 hours and most preferably within 1 hour. Epoxy or polyepoxide is a thermosetting epoxide polymer that cures (polymerizes and crosslinks) when mixed with a catalyzing agent or “hardener.” Epoxies contain a reactive group resulting from the union of an oxygen atom with two other atoms (usually carbon) that are joined in some other way. Typically, epoxies contain a 3-membered ring consisting of one oxygen and two carbon atoms. Most common epoxy resins are produced from a reaction between epichlorohydrin and bisphenol-A.

Raw epoxy resins are not manufactured in a usable form and must be “formulated” prior to use, i.e. the raw epoxy resins have to be modified by adding different materials. There are hundreds of ways that epoxy resins can be modified, such as, by adding mineral fillers (for example, talc, silica, alumina, etc.), by adding flexibilizers, viscosity reducers, colorants, thickeners, accelerators, adhesion promoters, etc. These modifications are made to reduce costs, to improve performance, and to improve rheological properties for processing convenience. As a result, thousands of epoxy resin formulations are available to satisfy the requirements of a wide variety of applications and markets. It has been found that a cycloaliphatic amine epoxy is particularly well suited for coating steel, especially steel sheet piling sections. It has also been found that a cycloaliphatic amine epoxy has synergistic effects when used in combination with the polyurethane coatings of the present invention.

In a preferred embodiment, the epoxy can be a fusion bonded epoxy (FBE) coating, also known as fusion-bond epoxy powder coating, which is an epoxy based powder coating. FBE coatings are widely used to prevent deterioration due to corrosion and to protect various sizes of steel pipes used in pipeline construction, concrete reinforcing rebars and on a wide variety of piping connections and valves. FBE coatings are thermoset polymer coatings. They come under the category of “protective coatings” in paints and coating nomenclature. The name “fusion-bond epoxy” is derived from the way of resin cross-linking and their method of application which is different from that of a conventional liquid paint. FBE coatings are in the form of dry powder at normal atmospheric temperatures. The resin and hardener parts in the dry powder remain unreacted at normal storage conditions. At typical coating application temperatures, usually in the range of 180 to 250° C., the contents of the powder melt and transform to a liquid form. When it is applied, the liquid FBE film “wets and flows on to” the steel surface and rapidly becomes a solid coating by chemical cross-linking, assisted by heat. This process is known as “fusion bonding.” The chemical cross-linking reaction taking place in this case is “irreversible,” which means once the curing takes place, the coating cannot be converted back into its original form by any means. Application of further heating will not “melt” the coating and, thus, it is known as a “thermoset” coating.

The thickness of the epoxy coat can vary from about 2 mils to about 25 mils or more. Thicknesses above 25 mils provide greater protection, but it has been found that the benefits are not proportional to the increased cost. Preferably, the epoxy coating has a thickness of from about 4 mils to about 16 mils and, most preferably from about 8 mils to about 12 mils. A thickness of about 10 mils has been found to effectively protect the underlying metal for most applications. When a coat thickness exceeds about 10 mils in thickness, it should be applied in multiple coating operations, with each coat preferably having a thickness between about 4-6 mils depending on the type of epoxy. This ensures an even layer thickness and facilitates the drying/curing of the epoxy. The time interval between applications of successive layers can vary depending on the type of epoxy, the thickness of the layer and the ambient temperature. For example, a layer having a thickness of between 4-6 mils should be allowed to cure between 2 hours (at a temperature of 90° F.) and 12 hours (at a temperature of 50° F.) for recoating with the same epoxy. These curing times are typically doubled for an epoxy topcoat, or if another coat of a different material is being applied to the epoxy coat.

### Polyurethane Layer

After the epoxy coating is allowed to dry or cure for a period of time based on the type of epoxy that is used and the thickness of the coat, a polyurethane layer is applied to the epoxy coating on at least one surface of the metal. As used in the present disclosure, the term “polyurethane” refers in general to any polymer consisting of a chain of organic units joined by urethane links. Polyurethane is a unique material that offers the elasticity of rubber combined with the toughness and durability of metal. Polyurethanes can be manufactured in an extremely wide range of grades, in densities from 6 kg/m³ to 1220 kg/m³, and in a very broad hardness range. Accordingly, polyurethanes provide a coating material with high abrasion resistance and excellent physical properties. Unlike drying oils and alkyds, which cure after evaporation of the solvent and reaction with oxygen from the air, polyurethane coatings cure after evaporation of the solvent by a variety of reactions of chemicals within the original mix, or by reaction with moisture from the air. Certain products are “hybrids” and combine different aspects of their parent components. Polyurethanes also have excellent adhesive characteristics, which allows polyurethane coatings to directly adhere to most surfaces without the need for additional layers.

A polyurethane layer is applied as an exterior layer to one or both of the epoxy layers to protect the epoxy layer and provide superior impact and abrasion-resistance. Preferred polyurethanes are aliphatic polyurethanes, which are very stable when exposed to ultraviolet light, weathering and hydrolysis. Aliphatic polyurethane coatings are produced as a result of the reaction between aliphatic isocyanates (i.e., their molecular structure contains a straight chain of hydrocarbons) and polyester or acrylic polyols. “Isocyanate” is a generic term for those compounds that contain the isocyanate (—NCO) group and are distinguished by the number of isocyanate groups. Monoisocyanates contain one group, diisocyanates contain two groups and polyisocyanates contain three or more groups. Monoisocyanates are often of no value in coatings except possibly as a moisture absorber/reactant, because they cannot build the polymeric structure. Diisocyanates are preferred for use in aliphatic polyurethane coatings and the preferred diisocyanates are diphenylmethane diisocyanate (MDI), toluene diisocyanate (TDI), hexamethylene diisocyanate (HDI), and isophorone diisocyanate (IPDI), with the most preferred diisocyanates being HDI and IPDI. The most preferred aliphatic polyurethane is aliphatic acrylic polyurethane, which has been found to be superior to other types of polyurethane in providing an impact and abrasion-resistant exterior coating for epoxy undercoats.

The exterior polyurethane layer or layers can have a thickness of from about 2 mils to 24 mils, preferably from about 2 mils to 14 mils, more preferably from about 4 mils to 12 mils and most preferably from about 6 mils to 10 mils. A polyurethane layer thickness of about 8 mils has been found to provide excellent protection for the epoxy coating in most applications, but when frequent impacts are expected or severe abrasive conditions are encountered thicker polyurethane layers are preferred. When a polyurethane coat thickness exceeds about 2-4 mils in thickness, it should preferably be applied in multiple coating operations, with each coat preferably having a thickness of between about 1-2 mils depending on the type of polyurethane. Multiple layers provide a uniform thickness and allow the polyurethane to dry more completely. The time interval between applications of successive layers can vary depending on the type of polyurethane, the thickness of the layer and the ambient temperature. A layer having a thickness of between 1-2 mils should be allowed to dry between 4 hours (at a temperature of 90° F.) and 36 hours (at a temperature of 35° F.) before it is handled or recoated. After the last polyurethane coat is applied, it takes between 5 days (at a temperature of 90° F.) and 14 days (at a temperature of 35° F.) before it is completely cured.

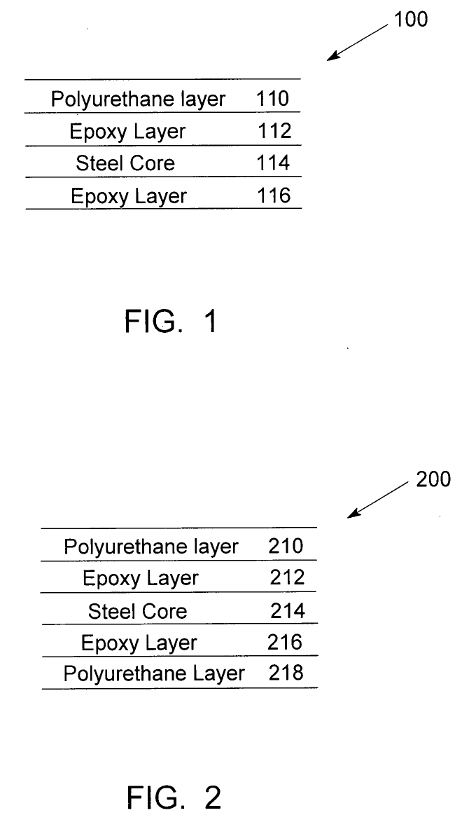

Preferred embodiments of the present invention can be better understood by referring to the figures. FIG. 1 shows a preferred structure 100 having a steel core 114 coated with an epoxy layer 112, 116 on both sides of the steel core 114. After the epoxy has dried, one of the exterior epoxy layers 112, 116 is coated with a polyurethane layer 110. This embodiment is preferred in applications where the sheet piling section is exposed to abrasive forces on only one surface. It is also preferred in applications where the sheet piling forms the interior wall of a structure such as a parking garage. In these cases, only the surface facing away from the interior of the structure has a polyurethane exterior surface and the surface facing the interior of the structure has an epoxy layer, which can be painted. The epoxy layer provides a good base layer for applying other paints and coatings while coatings and paints do not easily adhere to polyurethane layers.

FIG. 2 shows a preferred structure 200 having a steel core 214 coated with an epoxy layer 212, 216 on both sides of the steel core 214 and two polyurethane exterior layers 210, 218. This structure 200 is similar to the structure 100 illustrated in FIG. 1, but it also includes a second polyurethane exterior layer 218. The two polyurethane exterior layers 210, 218 provide maximum abrasion protection on both surfaces of the coated sheet piling section 200.

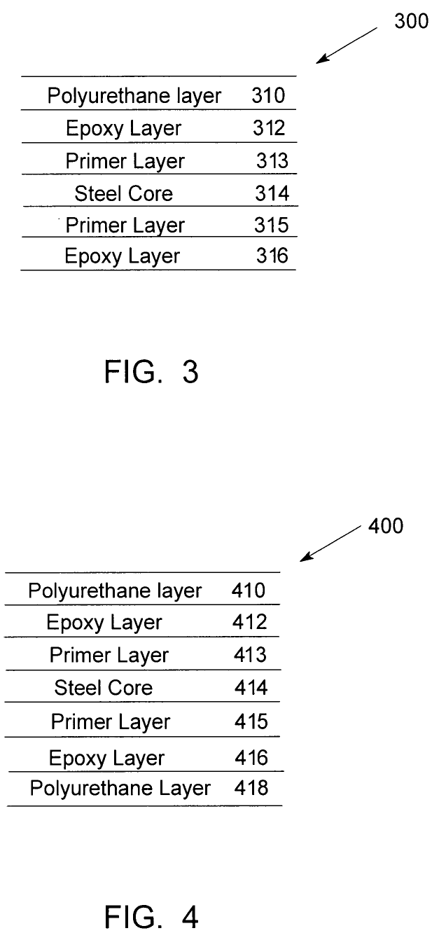

FIG. 3 shows a structure 300 similar to the structure 100 in FIG. 1 except that it also includes a primer layer 313, 315 on each side of the steel core 314; between the steel core 314 and the two epoxy layers 312, 316. The structure 300 also includes one polyurethane exterior layer 310. The primer layers 313, 315 provide added protection for the steel core 314 and improve the adhesion of the epoxy layers 312, 316.

FIG. 4 shows a preferred structure 400 similar to the structure 300 in FIG. 3 with two primer layers 413, 415 on the opposing surfaces of the steel core 414 and two epoxy layers 412, 416 applied over the primer layers 413, 415. The structure 400 also has a second exterior layer of polyurethane 418. This structure 400 offers the maximum protection for the steel sheet piling section 414.

### EXAMPLES

The examples set forth below serve to provide further appreciation of the invention but are not meant in any way to restrict the scope of the invention.

### Example 1

An AZ series sheet piling section manufactured by Skyline Steel, LLC and having a thickness of approximately 0.500 inches was prepared by sandblasting (using a near white blast cleaning procedure) all exterior surfaces until all of the surfaces of the sheet piling section had a shiny appearance. The prepared surfaces were spray-coated (using a multiple pass airless spray technique) with an inorganic zinc primer and allowed to dry for approximately 24 hours. Each side of the sheet piling section was then spray-coated with a cycloaliphatic amine epoxy layer having a thickness of about 10 mils in two spraying applications with about 3 hours between the application of layers in order to allow the first layer to cure. After the second coat was applied, the epoxy layer was allowed to cure over night (approximately 26 hours). The next day, both of the epoxy layers were spray-coated with aliphatic acrylic polyurethane in three spraying applications with about 6 hours between the application of layers to allow time for drying. The aliphatic acrylic polyurethane formed a pair of exterior layers having a thickness of about 8 mils. FIG. 4 shows the layers of the sheet piling section after the application of the coating system.

The coated sheet piling section was found to have superior corrosion, impact and abrasion-resistance properties to sheet piling sections that had only an epoxy coating or a polyurethane coating. The following tests were performed on the sheet piling section and the results of the tests are listed below.

1. Cathodic Disbondment Testing (ASTM G80 and ASTM G95)

This test method is typically used to evaluate the long-term performance of barrier coatings used to protect metal used in underground applications. The test consisted of placing a test specimen coated with the coating system described in Example 1 in series with a magnesium anode as part of a galvanic cell. The electrolyte was a mixture of various salts including NaCl, KCl, and sodium bicarbonate. Before the coated sheet of steel was placed in the electrolyte, the coating was intentionally damaged in several locations by striking it with a hammer to provide several sites (“scribes”) where edge corrosion could occur. The sample remained in the electrolyte for six months and then the edges of the damaged areas were evaluated to determine the extent of disbondment (i.e., how well the coating remained on the steel). The tests showed that there was no blistering, rusting or delaminating.

2. Salt Spray Testing (ASTM B117)

ASTM B 117 is the most commonly used method of salt spray testing of inorganic and organic coatings. Salt spray testing is used to evaluate the uniformity of thickness and degree of porosity of metallic and nonmetallic protective coatings. The test introduced several sprays in a closed chamber so that a specimen prepared according to Example 1 (and damaged to form several scribes) was exposed to the sprays at specific locations and angles. The concentration of the NaCl solution was about 10% by weight. After 2,100 hours, the coated steel sheet was examined and found to have less than 2 mm creep at the scribe (the intentionally damaged area).

3. Prohesion Testing (ASTM G-85, Method A5)

“ProHesion” is an acronym for “protection and adhesion.” The Prohesion Test was developed to simulate natural weathering and provide a realistic method of accelerated corrosion testing for industrial, marine and structural steel coatings. Test regimes include cyclic wetting and drying using a dilute solution of ammonium sulphate and sodium chloride. The tests show a close correlation with long term outdoor exposure and produce excellent filliform corrosion (a thread-like form of corrosion that occurs under organic coatings) results and realistic testing of water based coatings. A prohesion test was performed on a specimen prepared according to Example 1 (and damaged to form several scribes) for 1,600 hours. The specimen was examined and found to have a 1 mm creep at scribe and medium #2 blisters at scribe.

4. Salt Water Immersion Test (JIS-A6205)

According to this test method, a specimen prepared according to Example 1 (and damaged to form several scribes) was half-immersed in a solution containing:

| Material | Symbol | % Weight |
|---|---|---|
| Sodium chloride | NaCl | 0.500 |
| Magnesium chloride | MgCl₂ × 6H₂O | 0.200 |
| Sodium sulfate | Na₂SO₄ | 0.080 |
| Calcium chloride | CaCl₂ | 0.030 |
| Potassium chloride | KCl | 0.015 |
| Calcium hydroxide | Ca(OH)₂ | 0.600 |
| Water | H₂O | ≈98.7% |

After 6 months immersed in the salt water solution, the specimen was examined and found to have no blisters, rusting or delaminating.

### 5. Gasoline Immersion Test

A specimen prepared according to Example 1 (and damaged to form several scribes) was immersed in gasoline for 11 months and then examined. The specimen had no blisters, rusting or delaminating.

6. Flexibility Mandrel Bend Test (ASTM D522)

The Flexibility Mandrel Bend Test (ASTM D522) is used to determine the resistance to cracking (flexibility) of attached organic coatings on substrates of sheet metal or rubber-type materials. A specimen with the structure shown in FIG. 4 (and damaged to form several scribes) and having a 5-6 mils dft coating on a 1/16-inch steel sheet was tested in accordance with the Flexibility Mandrel Bend Test for 50 cycles and then examined. The specimen was found to have a 37.1% elongation, which passed the test requirements.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A coated sheet piling section comprising:
a steel core having a pair of opposing surfaces;
a first and a second cycloaliphatic amine epoxy layer, wherein the steel core is disposed between the cycloaliphatic amine epoxy layers; and
a first layer of aliphatic acrylic polyurethane disposed on one of the two cycloaliphatic amine epoxy layers.

2. The coated sheet piling section in accordance with claim 1, wherein each of the two cycloaliphatic amine epoxy layers has a thickness of from about 4 mils to about 16 mils.

3. The coated sheet piling section in accordance with claim 1, wherein the first layer of aliphatic acrylic polyurethane has a thickness of from about 2 mils to about 14 mils.

4. The coated sheet piling section in accordance with claim 1, wherein a second layer of aliphatic acrylic polyurethane is disposed on the uncoated cycloaliphatic amine epoxy layer.

5. The coated sheet piling section in accordance with claim 4, wherein each of the two aliphatic acrylic polyurethane layers has a thickness of from about 2 mils to about 14 mils.

6. The coated sheet piling section in accordance with claim 1, wherein each of the two cycloaliphatic amine epoxy layers has a thickness of from about 4 mils to about 16 mils and the first layer of aliphatic acrylic polyurethane has a thickness of from about 2 mils to about 14 mils.

7. The coated sheet piling section in accordance with claim 1, further comprising a first primer layer and a second primer layer, wherein the first primer layer is disposed between the first cycloaliphatic amine epoxy layer and the steel core and the second primer layer is disposed between the second cycloaliphatic amine epoxy layer and the steel core.

9. The coated sheet piling section in accordance with claim 1, wherein the opposing surfaces of the steel core are substantially free of oxidized metals prior to the application of the two cycloaliphatic amine epoxy layers.

10. The coated sheet piling section in accordance with claim 1, wherein the opposing surfaces of the steel core are substantially free of oxidized metals and coated with a primer layer prior to the application of the two cycloaliphatic amine epoxy layers.

11. The coated sheet piling section in accordance with claim 4, wherein the first and second cycloaliphatic amine epoxy layers each have a first thickness and the first and second aliphatic acrylic polyurethane layers each have a second thickness, and wherein the ratio of the first thickness to the second thickness is from about 3:2 to about 1:1.

12. A coated sheet piling section comprising:
a steel core having a pair of opposing surfaces, wherein the opposing surfaces are substantially free of oxidized metals;
a first primer layer and a second primer layer, wherein the steel sheet piling section is adjacent to and disposed between the two primer layers;
a first and a second cycloaliphatic amine epoxy layer, wherein the steel core and the two primer layers are disposed between the two cycloaliphatic amine epoxy layers and wherein each of the two cycloaliphatic amine epoxy layers has a thickness of from about 4 to about 16 mils; and
a first layer of aliphatic acrylic polyurethane, wherein the first aliphatic acrylic polyurethane layer is a first exterior layer and has a thickness of from about 2 to about 14 mils.

13. The coated sheet piling section in accordance with claim 12, further comprising a second aliphatic acrylic polyurethane layer, wherein the second aliphatic acrylic polyurethane layer is a second exterior layer.

14. The coated sheet piling section in accordance with claim 12, wherein each of the two cycloaliphatic amine epoxy layers has a thickness of from about 8 mils to about 12 mils and the first layer of aliphatic acrylic polyurethane has a thickness of from about 6 mils to about 10 mils.

15. The coated sheet piling section in accordance with claim 13, wherein each of the two cycloaliphatic amine epoxy layers has a thickness of about 10 mils and each of the two aliphatic acrylic polyurethane layers has a thickness of about 8 mils.

16. The coated sheet piling section in accordance with claim 12, wherein the first primer layer and the second primer layer are inorganic zinc primers.

17. A method of forming a durable steel sheet piling section comprising:
providing a steel sheet piling section having a pair of opposing surfaces;
abrading the opposing surfaces of the steel sheet piling section to substantially remove all metal oxides;
applying a first and second cycloaliphatic amine epoxy layer to the opposing surfaces; and
applying a first aliphatic acrylic polyurethane layer onto the first or second cycloaliphatic amine epoxy layer.

18. The method of forming a durable steel sheet piling section according to claim 17, wherein a second aliphatic acrylic polyurethane layer is applied to the uncoated cycloaliphatic amine epoxy layer.

19. The method of forming a durable steel sheet piling section according to claim 17, wherein the opposing surfaces of the sheet piling section are abraded by sand blasting.

20. The method of forming a durable steel sheet piling section according to claim 17, further comprising applying a primer layer to each of the abraded opposing surfaces prior to applying the epoxy layers.

21. A method of forming a coated steel sheet comprising:
providing a steel sheet having opposing surfaces and a thickness of from about 0.375 to about 1 inch;
abrading the steel sheet to remove about 1 mil of thickness from each of the opposing surfaces;
applying a primer layer to each of the abraded opposing surfaces;
applying a cycloaliphatic amine epoxy layer having a thickness of between about 8 mils and about 12 mils onto each of the two primer layers;
curing the cycloaliphatic amine epoxy layers; and
applying a first aliphatic acrylic polyurethane layer having a thickness of from about 6 mils to about 10 mils onto at least one of the cycloaliphatic amine epoxy layers.

22. The method of forming a coated steel sheet according to claim 21, wherein the primer layers are inorganic zinc primers.

23. The method of forming a coated steel sheet according to claim 21, wherein a second aliphatic acrylic polyurethane layer is applied to the uncoated cycloaliphatic amine epoxy layer.

24. The method of forming a coated steel sheet according to claim 21, wherein the opposing surfaces of the sheet piling section are abraded by sand blasting.
